(19) United States
(12) Patent Application Publication
(10) Pub. No.: US 2011/0310081 A1
(43) Pub. Date: Dec. 22, 2011

(54) MULTI-DISPLAY SYSTEM AND METHOD THEREOF

(76) Inventor: Hung-Huei Hsu, Hsinchu County (TW)

(21) Appl. No.: 12/854,169

(22) Filed: Aug. 11, 2010

(30) Foreign Application Priority Data
Jun. 22, 2010 (TW) 099120324

(51) Int. Cl. G09G 5/00; G09G 3/30; G09G 3/36

(52) U.S. Cl. 345/212; 345/87; 345/76

(57) ABSTRACT

A display displays a plurality of sequential image; each sequential image of the plurality of sequential images has corresponding gratings. When the display displays the sequential image of the plurality of sequential images, the gratings are turned on. When the display displays another sequential image of the plurality of sequential images, the gratings are turned off.

### BACKGROUND OF THE INVENTION

1. Field of the Invention

The present invention is related to a multi-display system and method thereof, and particularly to a multi-display system capable of displaying different sequential images for different sensors and method thereof.

2. Description of the Prior Art

When two or more video frames are displayed on the same display, many television manufacturers split a display region into a plurality of windows for displaying different video frames, or overlay one or more sub-video frames in a main-video frame (picture-in-picture, PiP), to achieve the display displaying two or more video frames.

However, both the split display region and picture-in-picture (PiP) have disadvantages. For example, in the split display region method, both video frames are shrunk to fit into the same display, and in the PiP method, one or more sub-video frames are overlaid in the main-video frame. Therefore, in the split display region method, a sub-frame for each video frame is too small or a proportion of an object displayed in a sub-frame is improper; in the PiP method, viewers of the main-video frame may miss key moments usually because one or more sub-video frames are overlaid in the main-video frame. In addition, viewers viewing different video frames are often distracted by the other frame when two or more video frames are displayed on the same display.

### SUMMARY OF THE INVENTION

An embodiment of the present invention provides a multi-display system. The multi-display system comprises a display, a common signal source, and a plurality of gratings. The display is used for displaying a plurality of sequential images. The common signal source is coupled to the display for providing the display with a common voltage signal so that the display displays the plurality of sequential images according to the common voltage signal. Each grating of the plurality of gratings corresponds to a sequential image of the plurality of sequential images for being turned on when the display displays the sequential image and the common voltage signal is stable, and turned off before the common voltage signal is changed to another voltage state.

Another embodiment of the present invention provides a multi-display method. The multi-display method comprises providing a display with a common voltage signal so that the display displays a plurality of sequential images according to the common voltage signal; and a grating of a plurality of gratings corresponding to a sequential image of the plurality of sequential images being turned on when the display displays the sequential image of the plurality of sequential images and the common voltage signal is stable, and turned off before the common voltage signal is changed to another voltage state.

The present invention provides a multi-display system and method thereof. The multi-display system and method thereof use a display to display a plurality of sequential images, and each sequential image has a corresponding grating. When the display displays the sequential image, turning-on and turning off of the corresponding grating is in sync with the sequential image so that a corresponding sensor only senses the sequential image through the corresponding grating. Therefore, the multi-display system and related method of the present invention can display the plurality of sequential images on one display for a plurality of sensors to achieve a multi-display purpose.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a multi-display system according to an embodiment of the present invention.

FIG. 2 is a timing diagram illustrating the first sensor and the second sensor sensing images through the first grating and the second grating respectively.

FIG. 3 is a diagram illustrating a multi-display system according to another embodiment of the present invention.

FIG. 4 is a timing diagram illustrating the first sensor, the second sensor, and the third sensor sensing images through the first grating, the second grating, and the third grating respectively.

FIG. 5 is a flowchart illustrating a multi-display method according to another embodiment of the present invention.

### DETAILED DESCRIPTION

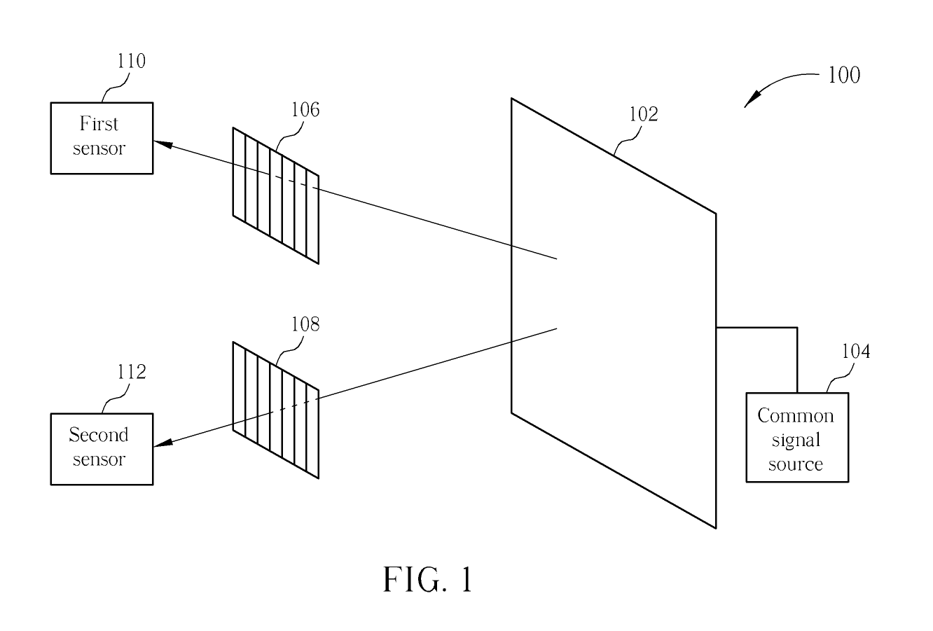

Please refer to FIG. 1. FIG. 1 is a diagram illustrating a multi-display system 100 according to an embodiment of the present invention. The multi-display system 100 comprises a display 102, a common signal source 104, a first grating 106, a second grating 108, a first sensor 110, and a second sensor 112. The display 102 is used for displaying a plurality of sequential images, where the display 102 is a liquid crystal display, an electrophoresis display, or a micro-electro-mechanical systems (MEMS) display. The common signal source 104 is electrically connected to the display 102 for providing the display 102 with a common voltage signal so that the display 102 can display the plurality of sequential images according to the common voltage signal. The first grating 106 corresponds to a first sequential image of the plurality of sequential images for being turned on when the display 102 displays the first sequential image and the common voltage signal is stable, and turned off before the common voltage signal is changed to another voltage state. The second grating 108 corresponds to a second sequential image of the plurality of sequential images for being turned on when the display 102 displays the second sequential image and the common voltage signal is stable, and turned off before the common voltage signal is changed to another voltage state. The first sensor 110 is used for sensing the first sequential image displayed on the display 102 through the first grating 106. The second sensor 112 is used for sensing the second sequential image displayed on the display 102 through the second grating 108, where the first sensor 110 and the second sensor 112 are eyes of viewers or devices with sensing functions. In addition, the first grating 106 is installed between the display 102 and the first sensor 110, and the second grating 108 is installed between the display 102 and the second sensor 112. As shown in FIG. 1, both of the first grating 106 and the second grating 108 are liquid crystal displays, materials having controllable transparency, shutter glasses, and/or a combination thereof.

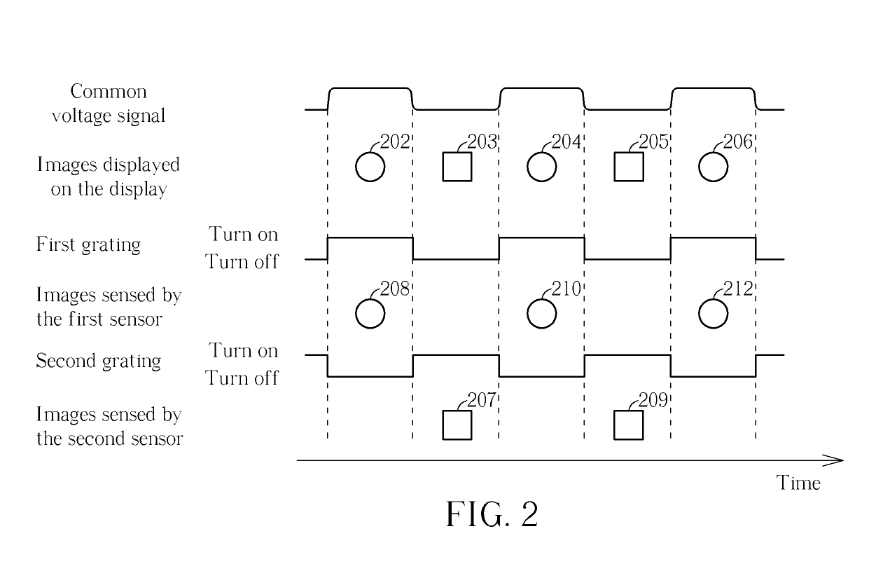

Please refer to FIG. 2. FIG. 2 is a timing diagram illustrating the first sensor 110 and the second sensor 112 sensing images through the first grating 106 and the second grating 108 respectively. The display 102 displays the first sequential images 202, 204, and 206, and the second sequential images 203 and 205. The first grating 106 is turned on when the display 102 displays the first sequential images 202, 204, and 206 and the common voltage signal is stable, and turned off before the common voltage signal is changed to another voltage state. Therefore, the first sensor 110 only senses the first sequential images 208, 210, and 212 through the first grating 106. The second grating 108 is turned on when the display 102 displays the second sequential image 203 and 205 and the common voltage signal is stable, and turned off before the common voltage signal is changed to another voltage state. Therefore, the second sensor 112 only senses the second sequential images 207 and 209 through the second grating 108.

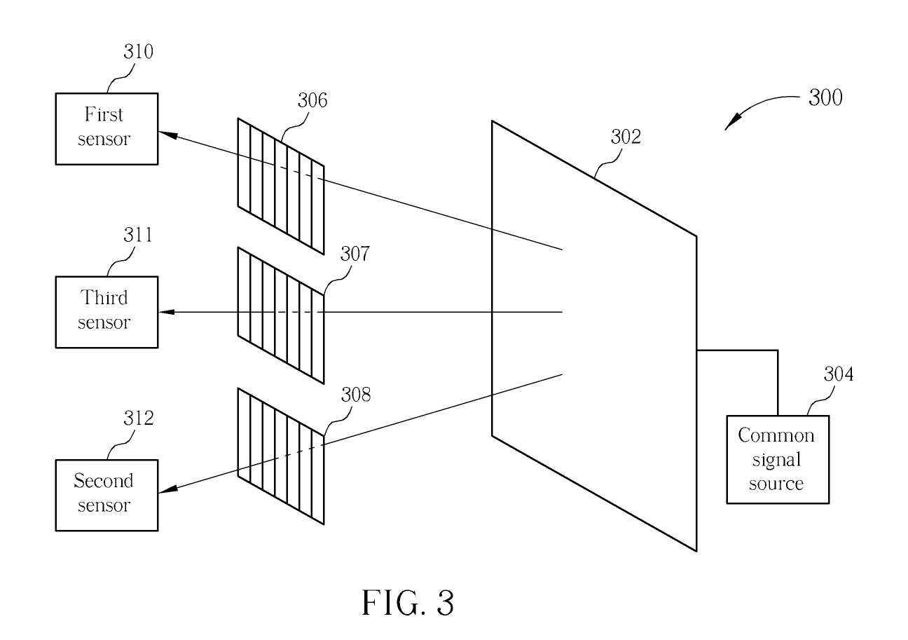

Please refer to FIG. 3. FIG. 3 is a diagram illustrating a multi-display system 300 according to another embodiment of the present invention. A difference between the multi-display system 300 and the multi-display system 100 is that a display 302 displays three sequential images, and the multi-display system 300 further comprises a third grating 307 and a third sensor 311, where the third sensor 311 senses the third sequential image displayed on the display 102 through the third grating 307. Further, subsequent operational steps of the multi-display system 300 are the same as for the multi-display system 100, so further description thereof is omitted for simplicity.

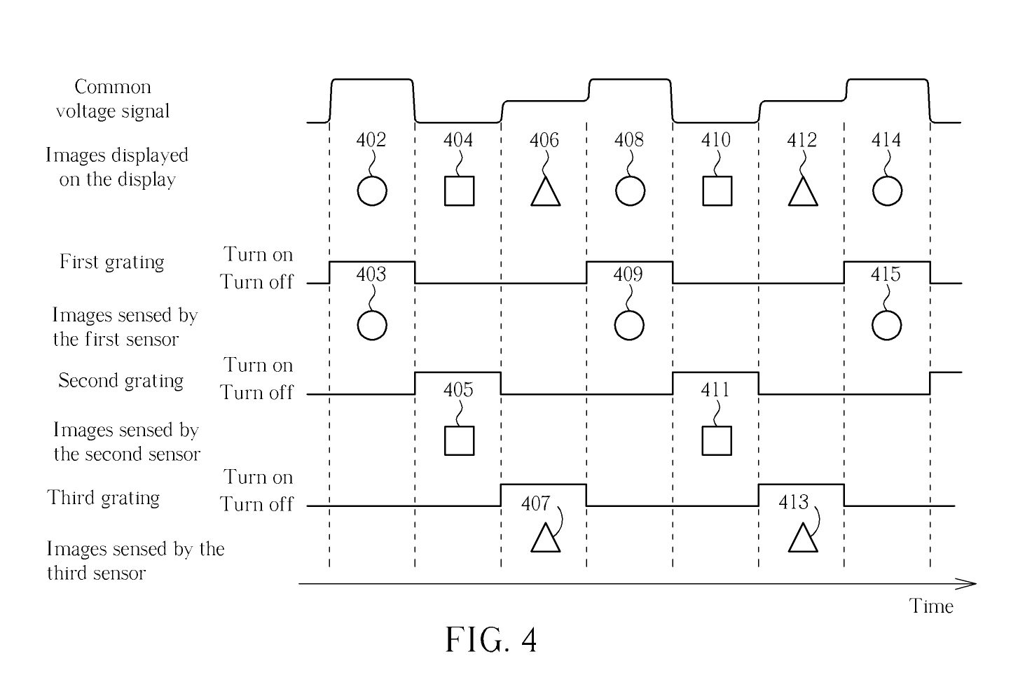

Please refer to FIG. 4. FIG. 4 is a timing diagram illustrating the first sensor 310, the second sensor 312, and the third sensor 311 sensing images through the first grating 306, the second grating 308, and the third grating 307, respectively. The display 302 displays the first sequential images 402, 408, and 414, the second sequential images 404 and 410, and the third sequential images 406 and 412. The first grating 306 is turned on when the display 102 displays the first sequential images 404, 408, and 414 and the common voltage signal is stable, and turned off before the common voltage signal is changed to another voltage state. Therefore, the first sensor 310 only senses the first sequential images 403, 409, and 415 through the first grating 306. The second grating 308 is turned on when the display 102 displays the second sequential images 404 and 410 and the common voltage signal is stable, and turned off before the common voltage signal is changed to another voltage state. Therefore, the second sensor 312 only senses the second sequential images 405 and 411 through the second grating 308. The third grating 307 is turned on when the display 102 displays the third sequential images 406 and 412 and the common voltage signal is stable, and turned off before the common voltage signal is changed to another voltage state. Therefore, the third sensor 311 only senses the third sequential images 407 and 413 through the third grating 307.

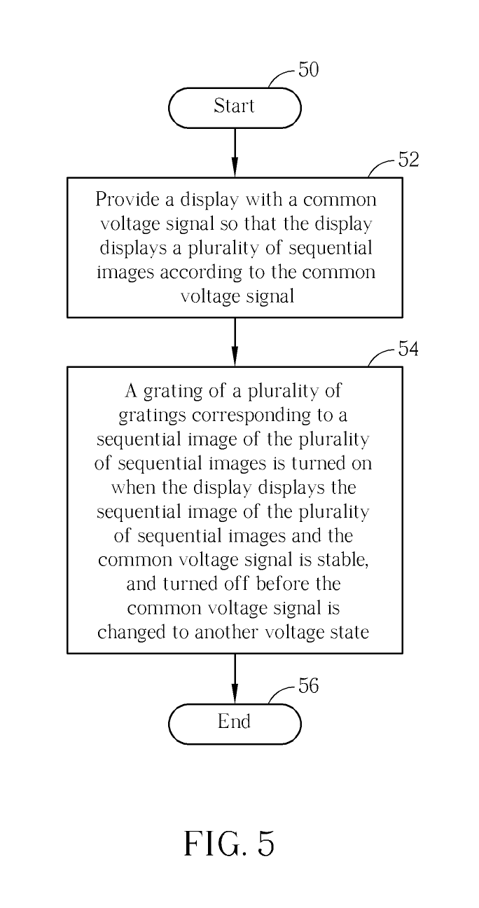

Please refer to FIG. 5. FIG. 5 is a flowchart illustrating a multi-display method according to another embodiment of the present invention. Detailed steps are as follows:

Step 50: Start.

Step 52: Provide a display with a common voltage signal so that the display displays a plurality of sequential images according to the common voltage signal.

Step 54: A grating of a plurality of gratings corresponding to a sequential image of the plurality of sequential images is turned on when the display displays the sequential image of the plurality of sequential images and the common voltage signal is stable, and turned off before the common voltage signal is changed to another voltage state.

Step 56: End.

To sum up, the present invention is not limited to the display displaying two or three sequential images, that is to say, the display may display more than three sequential images. In addition, the multi-display system and the related method provided by the present invention use the display to display the plurality of sequential images and each sequential image has a corresponding grating. When the display displays the sequential image, turning-on and turning off of the corresponding grating is in sync with the sequential image so that a corresponding sensor only senses the sequential image of the plurality of sequential images through the corresponding grating. Therefore, the multi-display system and the related method of the present invention can display the plurality of sequential images on one display for a plurality of sensors, and each sensor can receive substantially complete, undistorted aspect ratio, non-scaled image information.

Those skilled in the art will readily observe that numerous modifications and alterations of the device and method may be made while retaining the teachings of the invention.

What is claimed is:

1. A multi-display system, comprising:
a display for displaying a plurality of sequential images;
a common signal source coupled to the display for providing the display with a common voltage signal so that the display displays the plurality of sequential images according to the common voltage signal; and
a plurality of gratings, wherein each grating corresponds to a sequential image of the plurality of sequential images for being turned on when the display displays the sequential image of the plurality of sequential images and the common voltage signal is stable, and turned off before the common voltage signal is changed to another voltage state.

2. The multi-display system of claim 1, wherein the display is a liquid crystal display.

3. The multi-display system of claim 1, wherein the display is an electrophoresis display.

4. The multi-display system of claim 1, wherein the display is a micro-electro-mechanical systems (MEMS) display.

5. The multi-display system of claim 1, wherein the plurality of gratings are a plurality of liquid crystal displays.

6. The multi-display system of claim 1, wherein the plurality of gratings are a plurality of materials having controllable transparency.

7. The multi-display system of claim 1, wherein the plurality of gratings are a plurality of shutter glasses.

8. The multi-display system of claim 1, wherein the plurality of gratings are a plurality of liquid crystal displays, a plurality of materials having controllable transparency, a plurality of shutter glasses, and/or a combination thereof.

9. The multi-display system of claim 1, wherein the multi-display system further comprises a plurality of sensors.

10. The multi-display system of claim 9, wherein the each grating is installed between the display and each sensor.

11. A multi-display method comprising:
providing a display with a common voltage signal so that the display displays a plurality of sequential images according to the common voltage signal; and
a grating of a plurality of gratings corresponding to a sequential image of the plurality of sequential images being turned on when the display displays the sequential image of the plurality of sequential images and the common voltage signal is stable, and turned off before the common voltage signal is changed to another voltage state.
